(19) United States
(12) Patent Application Publication
(10) Pub. No.: US 2022/0003872 A1
(43) Pub. Date: Jan. 6, 2022

(54) INFORMATION PROCESSING SYSTEM, INFORMATION PROCESSING METHOD, AND STORAGE MEDIUM

(71) Applicants: NEC Corporation, Minato-ku, Tokyo (JP); NEC PLATFORMS, LTD., Kanagawa (JP)

(72) Inventors: Jun UCHIMURA, Minato-ku, Tokyo (JP); Hiroshi TAKAHASHI, Kanagawa (JP)

(73) Assignee: NEC Corporation, Minato-ku, Tokyo (JP)

(21) Appl. No.: 17/293,539

(22) PCT Filed: Nov. 13, 2019
(86) PCT No.: PCT/JP2019/044601

§ 371 Date: May 13, 2021

(51) Int. Cl. G01S 17/88; G01S 7/481; G01S 17/08; B65G 67/04

(52) U.S. Cl. CPC G01S 17/88; G01S 7/4817; B65G 67/04; G01S 17/08; G01S 7/4814

(57) ABSTRACT

Provided are an information processing system, an information processing method, and a storage medium that can accurately acquire a loading rate of loads on a load-carrying platform of a vehicle. The information processing system includes: a ranging unit that acquires a distribution of distances to a load loaded on a load-carrying platform of a vehicle or to a floor surface of the load-carrying platform; and a loading rate acquisition unit that acquires a loading rate of the load on the load-carrying platform based on the distribution of the distances.

### TECHNICAL FIELD

The present invention relates to an information processing system, an information processing method, and a storage medium.

### BACKGROUND ART

Patent Literature 1 discloses a method of measuring the position of an object using a distance meter having an emission unit that emits light to an object, a receiving unit that receives reflected light reflected by the object, and a calculation unit that calculates the distance to a reflection point based on a result of the reception at the receiving unit. In the method disclosed in Patent Literature 1, the distance meter is moved so as to traverse an object placed on a trailer located at a distant place, and the calculation unit calculates the position of the object, the weight of the object, the height of the trailer, and the size of the object based on continuous output data from a light receiving unit between the distance meter and the object.

### CITATION LIST

### Patent Literature

PTL 1: Japanese Patent Application Laid-open No. H7-10466

### SUMMARY OF INVENTION

### Technical Problem

In the apparatus disclosed in Patent Literature 1, however, since only the position or the like of an object is measured, it is difficult to accurately acquire a loading rate of loads on a trailer.

In view of the problem described above, the example object of the present invention is to provide an information processing system, an information processing method, and a storage medium that can accurately acquire a loading rate of loads on a load-carrying platform of a vehicle.

### Solution to Problem

According to one example aspect of the present invention, provided is an information processing system including: a ranging unit that acquires a distribution of distances to a load loaded on a load-carrying platform of a vehicle or to a floor surface of the load-carrying platform; and a loading rate acquisition unit that acquires a loading rate of the load on the load-carrying platform based on the distribution of the distances.

According to another example aspect of the present invention, provided is an information processing method including: acquiring a distribution of distances to a load loaded on a load-carrying platform of a vehicle or to a floor surface of the load-carrying platform; and acquiring a loading rate of the load on the load-carrying platform based on the distribution of the distances.

According to yet another example aspect of the present invention, provided is a storage medium storing a program that causes a computer to perform: causing a ranging unit to acquire a distribution of distances to a load loaded on a load-carrying platform of a vehicle or to a floor surface of the load-carrying platform; and acquiring a loading rate of the load on the load-carrying platform based on the distribution of the distances.

### Advantageous Effects of Invention

According to the present invention, a loading rate of loads on a load-carrying platform of a vehicle can be accurately acquired.

### BRIEF DESCRIPTION OF DRAWINGS

FIG. 1 is a schematic diagram illustrating a configuration of a loading management system according to a first example embodiment of the present invention.

FIG. 2 is a block diagram illustrating a configuration of the loading management system according to the first example embodiment of the present invention.

FIG. 3 is a schematic diagram illustrating a ranging apparatus in the loading management system according to the first example embodiment of the present invention.

FIG. 4 is a flowchart illustrating operations of a loading rate acquisition system and a management server in the loading management system according to the first example embodiment of the present invention.

FIG. 5 is a schematic perspective view illustrating the structure of a ranging apparatus according to a second example embodiment.

FIG. 6 is a schematic front view illustrating the structure of the ranging apparatus according to the second example embodiment.

FIG. 7 is a schematic top view illustrating the structure of the ranging apparatus according to the second example embodiment.

FIG. 8 is a diagram of light paths when a reflective surface is provided through the vertex of a parabola.

FIG. 9 is a diagram of light paths when no reflective surface is provided through the vertex of a parabola.

FIG. 10 is a diagram of light paths when no reflective surface is provided through the vertex of a parabola.

FIG. 11 is a schematic top view illustrating the structure of a ranging apparatus according to a third example embodiment.

FIG. 12 is a schematic top view illustrating the structure of a ranging apparatus according to a fourth example embodiment.

FIG. 13 is a schematic perspective view illustrating the structure of a ranging apparatus according to a fifth example embodiment.

FIG. 14 is a schematic top view illustrating the structure of the ranging apparatus according to the fifth example embodiment.

FIG. 15 is a sectional view of a logarithm spiral reflecting mirror of the ranging apparatus according to the fifth example embodiment.

FIG. 16 is a diagram illustrating reflection of light at a reflective surface forming a logarithm spiral.

FIG. 17 is a schematic front view illustrating the structure of a ranging apparatus according to a sixth example embodiment.

FIG. 18 is a schematic top view illustrating the structure of the ranging apparatus according to the sixth example embodiment.

FIG. 19 is a schematic perspective view illustrating the structure of a ranging apparatus according to a seventh example embodiment.

FIG. 20 is a schematic top view illustrating the structure of the ranging apparatus according to the seventh example embodiment.

FIG. 21A is a schematic top view illustrating the structure of a ranging apparatus according to an eighth example embodiment.

FIG. 21B is a schematic side view illustrating the structure of the ranging apparatus according to the eighth example embodiment.

FIG. 22 is a block diagram illustrating a configuration of an information processing system according to another example embodiment.

### DESCRIPTION OF EMBODIMENTS

Exemplary example embodiments of the present invention will be described below with reference to the drawings. Throughout the drawings, the same components or corresponding components are labeled with the same references, and the description thereof may be omitted or simplified.

### First Example Embodiment

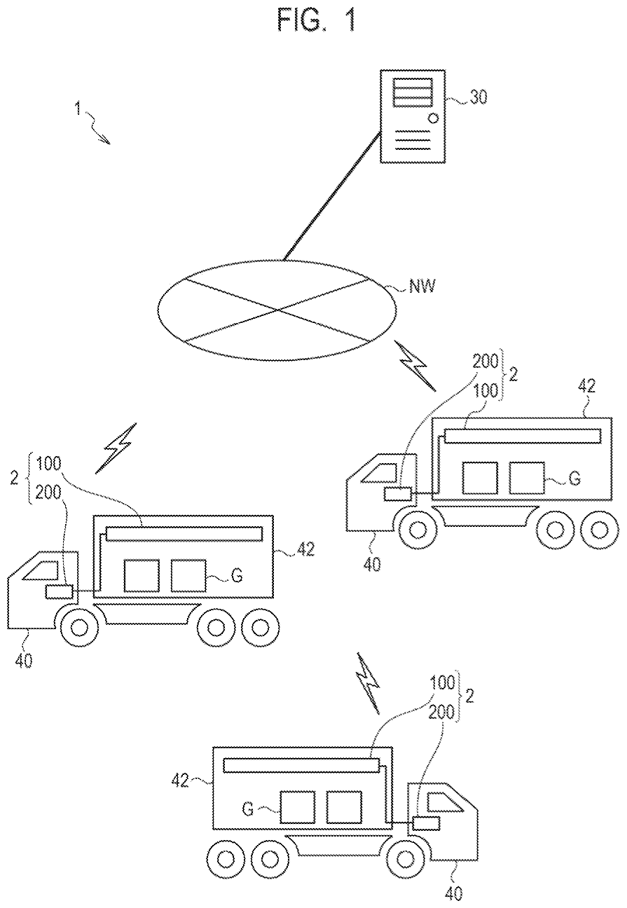

A loading management system according to a first example embodiment of the present invention will be described with reference to FIG. 1 to FIG. 4.

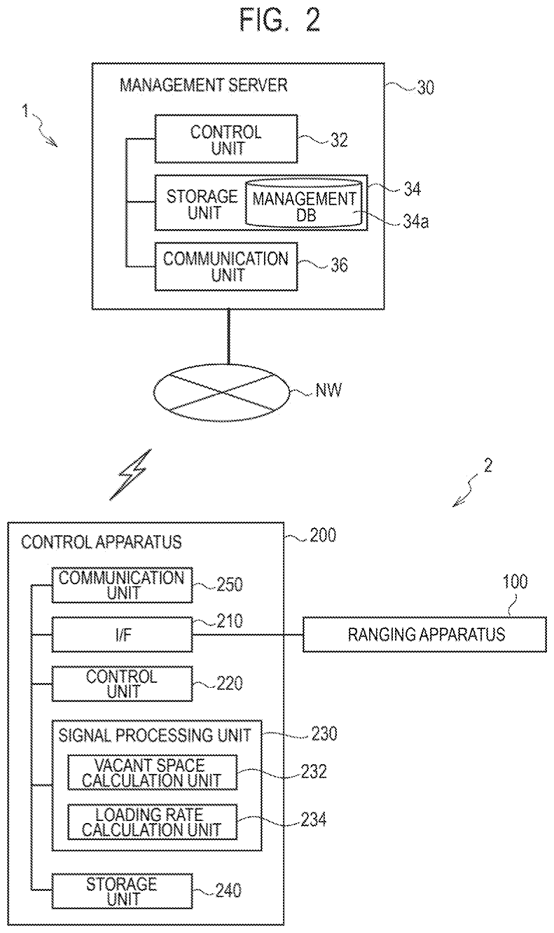

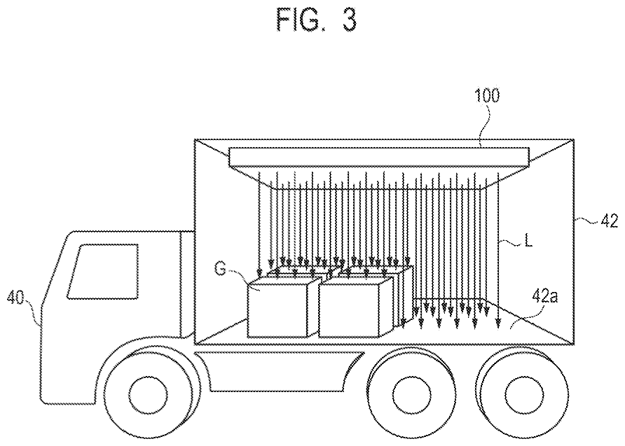

First, the configuration of the loading management system according to the present example embodiment will be described with reference to FIG. 1 to FIG. 3. FIG. 1 is a schematic diagram illustrating the configuration of the loading management system according to the present example embodiment. FIG. 2 is a block diagram illustrating the configuration of the loading management system according to the present example embodiment. FIG. 3 is a schematic diagram illustrating a ranging apparatus in the loading management system according to the present example embodiment.

As illustrated in FIG. 1 and FIG. 2, a loading management system 1 according to the present example embodiment includes a loading rate acquisition system 2 and a management server 30. The loading rate acquisition system 2 is mounted on each vehicle 40 such as a truck. The loading rate acquisition system 2 includes a ranging apparatus 100 and a control apparatus 200. The management server 30 is connected to a network NW. The network NW is formed of a Local Area Network (LAN), a Wide Area Network (WAN), a mobile communication network, or the like. The control apparatus 200 of the loading rate acquisition system 2 is able to connect to the network NW in a wireless scheme such as mobile communication, for example. The control apparatus 200 and the management server 30 can communicate with each other via the network NW. Note that the communication scheme of the control apparatus 200 may be suitably selected from a wireless scheme or a wired scheme in accordance with the installation place thereof, for example.

The loading rate acquisition system 2 is an information processing system and is mounted on the vehicle 40. For example, the vehicle 40 is a goods vehicle such as a truck that is loaded with and transports loads G. The loading rate acquisition system 2 may be mounted on a single vehicle 40 or a plurality of vehicles 40. Further, the type of the vehicle 40 is not particularly limited as long as it can be loaded with the load G without being limited to a truck.

The vehicle 40 has a cargo space 42 that is a box-shaped load-carrying platform loaded with the load G, for example. The ranging apparatus 100 is installed on the ceiling of the cargo space 42. The type of the cargo space 42 is not particularly limited and may be, for example, a van body type, a wing body type, a hooded flat body type, a refrigerator type, a freezer type, or the like. The cargo space 42 may be formed of a container used for transporting the load G, such as a shipping container. Note that the vehicle 40 may be a vehicle which has a load-carrying platform of the flat body type having no hood with the top opened instead of the cargo space 42 that accommodates a load inside the space. In such a case, the ranging apparatus 100 is installed above a space where the load G can be loaded onto a load-carrying platform via a support member or the like, for example. The vehicle 40 may be any vehicle that has a load-carrying platform that may be loaded with the load G as described above.

Note that the load G loaded in the cargo space 42 of the vehicle 40 is not particularly limited and may be any type of loads. Further, the state of the load G is not particularly limited and may be any state such as a state of being packed with a packing material such as a cardboard box, a state of being accommodated in a shipping container such as a pallet box, a bare state, or the like, for example.

The load G is loaded into the cargo space 42 of the vehicle 40, for example, at a vehicle berth such as a distribution center. The loading rate acquisition system 2 acquires a loading rate of the loads G in the cargo space 42 of the vehicle 40 having such the cargo space 42 loaded with the loads G. Note that the place where the load G is loaded into the cargo space 42 may be not particularly limited and may be various places without being limited to a vehicle berth.

The control apparatus 200 is installed in a cab, a chassis, the cargo space 42, or the like of the vehicle 40, for example. Note that the installation place in the vehicle 40 of the control apparatus 200 is not particularly limited and may be any places. Further, the control apparatus 200 is not necessarily required to be installed in the vehicle 40 and may be installed in a separate place from the vehicle 40, such as a base facility that manages the vehicles 40. In such a case, the control apparatus 200 is configured to be able to communicate with the ranging apparatus 100 in a wireless scheme. Further, in such a case, the control apparatus 200 may be connected to the network NW in a wired scheme.

The ranging apparatus 100 functions as a ranging unit that acquires distance distribution information and may be a Light Detection and Ranging (LiDAR) device, for example. The ranging apparatus 100 can acquire a distribution of distances from the ranging apparatus 100 to a target object by emitting light in a predetermined range and detecting reflected light from the target object. The ranging apparatus 100 may be more generally called a sensor device. The loading rate acquisition system 2 may be configured to have a plurality of ranging apparatuses 100. Note that, in the present specification, light is not limited to visible light and is intended to include light that is unable to be perceived by a naked eye, such as an infrared ray, an ultraviolet ray, or the like. Further, the ranging apparatus 100 is not limited to a LiDAR device and may be any apparatus that can acquire distance distribution information described later.

Specifically, the ranging apparatus 100 emits light to the floor surface of the cargo space 42 across a reference surface that is a plane along the floor surface of the cargo space 42 and detects reflected light from the load G loaded on the floor surface of the cargo space 42 or the floor surface of the cargo space 42. Thereby, the ranging apparatus 100 can acquire a two-dimensional distribution of the distances from the ranging apparatus 100 to the load G or to the floor surface of the cargo space 42 across the reference surface. Note that a specific configuration example of the ranging apparatus 100 will be described in second to eighth example embodiments.

The control apparatus 200 is an information processing apparatus such as a computer, for example. As illustrated in FIG. 2, the control apparatus 200 has an interface (I/F) 210, a control unit 220, a signal processing unit 230, a storage unit 240, and a communication unit 250. The interface 210 is a device that connects the control apparatus 200 and the ranging apparatus 100 to each other in a communicative manner by a wired connection or a wireless connection. Thereby, the control apparatus 200 and the ranging apparatus 100 are connected to each other in a communicative manner. The interface 210 may be a communication device based on a specification such as Ethernet (registered trademark), for example. The interface 210 may include a relay device such as a switching hub. When the loading rate acquisition system 2 has a plurality of ranging apparatuses 100, the control apparatus 200 can control the plurality of ranging apparatuses 100 by relaying communication via switching hubs or the like.

The control unit 220 controls the operation of the ranging apparatus 100 and the control apparatus 200. The signal processing unit 230 processes a signal acquired from the ranging apparatus 100 to acquire distance information on a distance from the ranging apparatus 100 to the floor surface or the load G in the cargo space 42. The functions of the control unit 220 and the signal processing unit 230 may be implemented when a processor such as a central processing unit (CPU) provided in the control apparatus 200 reads and executes a program from a storage device, for example. The storage unit 240 is a storage device that stores data acquired by the ranging apparatus 100, a program and data used for the operation of the control apparatus 200, or the like. Accordingly, the control apparatus 200 has a function of controlling the ranging apparatus 100 and a function of analyzing a signal acquired by the ranging apparatus 100.

The communication unit 250 connects to the network NW in a wireless scheme such as mobile communication to transmit and receive data to and from the management server 30 or the like via the network NW. The control unit 220 can communicate with an external apparatus such as the management server 30 via the communication unit 250.

Furthermore, the signal processing unit 230 according to the present example embodiment has a vacant space calculation unit 232 and a loading rate calculation unit 234 as a function unit forming a loading rate acquisition unit in order to acquire a loading rate of the loads G in the cargo space 42.

As illustrated in FIG. 3, the loads G are loaded on a floor surface 42a of the cargo space 42. The ranging apparatus 100 installed on the ceiling of the cargo space 42 emits light L to the floor surface 42a of the cargo space 42 across the reference surface along the floor surface 42a of the cargo space 42. For example, the ranging apparatus 100 can emit the light L in a direction orthogonal to the floor surface 42a as a direction crossing the floor surface 42a. Further, the ranging apparatus 100 can emit the light L, which includes parallel light rays parallel to each other, across the reference surface by scanning the reference surface with the light L. The scanning scheme with the light L is not particularly limited, and the ranging apparatus 100 can scan the reference surface with the light L by using a raster scan that repeats a scan to move the light L in the width direction of the cargo space 42 and a scan to move the light L in the front-back direction of the cargo space 42, for example.

The ranging apparatus 100 detects reflected light of the light L, which has been emitted to the floor surface 42a, from the load G or the floor surface 42a of the cargo space 42. Accordingly, the ranging apparatus 100 acquires distance distribution information indicating a two-dimensional distribution of the distances from the ranging apparatus 100 to the loads G or the floor surface 42a across the reference surface. Since the distance distribution is acquired by a scan with the light L including parallel light rays parallel to each other as described above, a distance distribution can be accurately acquired.

Note that the ranging apparatus 100 is not necessarily required to perform a scan with the light L including parallel light rays parallel to each other. The ranging apparatus 100 may be any ranging apparatus that emits the light L to a region where the load G can be loaded on the floor surface 42a, such as a ranging apparatus that performs a rotation scan with respect to a predetermined rotation axis, for example.

Further, the ranging apparatus 100 is not necessarily required to be formed as a single ranging apparatus and may be formed of a plurality of ranging apparatuses provided for each of a plurality of divided regions, for example.

The vacant space calculation unit 232 calculates the volume of a vacant space in which the load G can be loaded in the cargo space 42 based on distance distribution information acquired by the ranging apparatus 100. In the cargo space 42, a distance in the distance distribution information is the distance from the ranging apparatus 100 to the floor surface 42a in a region loaded with no load G. On the other hand, in the cargo space 42, a distance in the distance distribution information is the distance from the ranging apparatus 100 to the load G in a region loaded with the load G. Thus, in a region loaded with no load G, the distance in distance distribution information is longer than in a region loaded with the load G. Further, the distance in distance distribution information may change in accordance with the size of the loaded load G. That is, the larger the loaded load G is, the shorter the distance in distance distribution information is. The vacant space calculation unit 232 can calculates the volume of a vacant space based on a difference in the distance in distance distribution information due to the presence or absence of the loaded load G, the size of the load G, or the like.

Note that the vacant space calculation unit 232 can also calculate the floor surface area of a vacant space instead of calculating the volume of the vacant space. In such a case, the vacant space calculation unit 232 can detect the floor surface of a vacant space based on a difference in the distance in distance distribution information due to the presence or absence of the loaded load G and calculate the floor surface area of the vacant space.

The loading rate calculation unit 234 calculates the loading rate of the loads G in the cargo space 42 based on the volume or the floor surface area of a vacant space that is a quantity related to a vacant space calculated by the vacant space calculation unit 232. For example, the loading rate calculation unit 234 can calculates the loading rate of the loads G by dividing the difference between the volume of the maximum loading space of the cargo space 42 and the volume of a vacant space by the volume of the maximum loading space. The maximum loading space is the maximum space of the cargo space 42 that can be loaded with the load G. Further, for example, the loading rate calculation unit 234 can calculate the loading rate of the loads G by dividing the difference between the floor surface area of the maximum loading space of the cargo space 42 and the floor surface area of a vacant space by the floor surface area of the maximum loading space.

In such a way, the loading rate acquisition system 2 according to the present example embodiment is configured. The loading rate acquisition system 2 according to the present example embodiment can acquire a loading rate of the loads G in the cargo space 42 of the vehicle 40 based on distance distribution information acquired by the ranging apparatus 100 as described above.

Note that the configuration of the loading rate acquisition system 2 described above is an example, and the loading rate acquisition system 2 may further include an apparatus that controls the ranging apparatus 100 and the control apparatus 200 in an integral manner. Further, the loading rate acquisition system 2 may be an integrated type apparatus in which the function of the control apparatus 200 is embedded in the ranging apparatus 100.

The management server 30 is installed in a base facility such as a distribution center of a freight company or the like that manages the vehicles 40, for example. The management server 30 is configured to be able to manage a loading rate of the loads G in the cargo space 42 of one or a plurality of vehicles 40. The management server 30 has a control unit 32, a storage unit 34, and a communication unit 36, as illustrated in FIG. 2.

The control unit 32 controls the operation of the management server 30. The function of the control unit 32 may be implemented when a processor such as a CPU provided in the management server 30 reads and executes a program from a storage device, for example. The storage unit 34 is a storage device that stores a program and data used for the operation of the management server 30 or the like. The storage unit 34 stores a management database (DB) 34a that manages the vehicle 40 and the loads G loaded in the cargo space 42 of the vehicle 40. The control unit 32 can register, in the management DB 34a, and manage a loading rate acquired by the loading rate acquisition system 2 and transmitted to the management server 30 in association with identification information on the vehicle 40.

The communication unit 36 connects to the network NW in a wired scheme or a wireless scheme to transmit and receive data to and from the control apparatus 200 or the like of the loading rate acquisition system 2 via the network NW. The control unit 32 can communicate with an external apparatus such as the control apparatus 200 or the like of the loading rate acquisition system 2 via the communication unit 36.

In such a way, the management server 30 according to the present example embodiment is configured.

The loading rate acquisition system 2 according to the present example embodiment acquires the loading rate of the loads G in the cargo space 42 that is a load-carrying platform of the vehicle 40 based on distance distribution information acquired by the ranging apparatus 100. Thus, the loading rate acquisition system 2 according to the present example embodiment can accurately acquire the loading rate of the loads G in the cargo space 42. Therefore, according to the present example embodiment, it is possible to prevent the vehicle 40 with a low loading rate from transporting the loads G while the loading rate is still low and realize efficient transportation of the loads G.

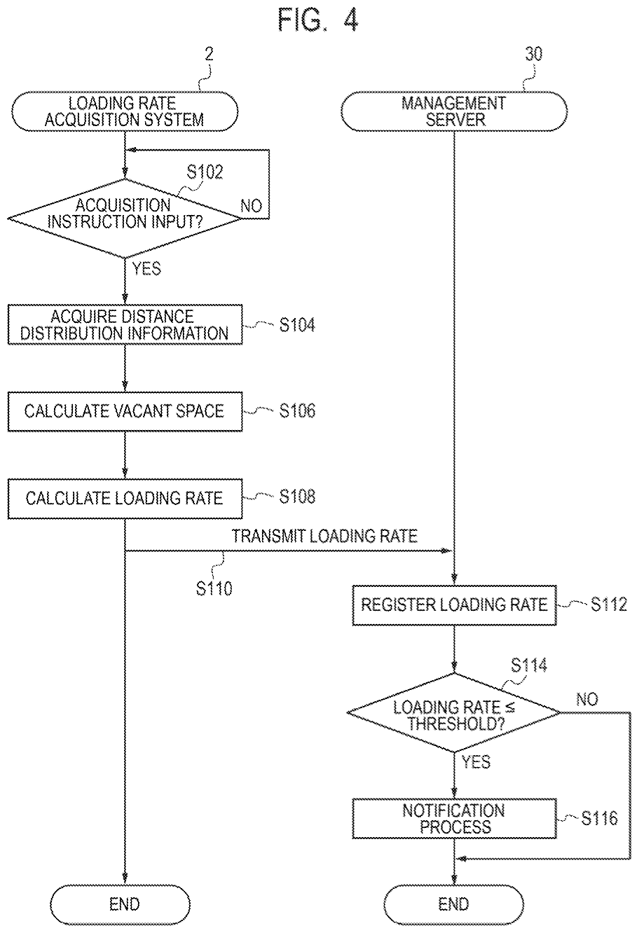

Next, the operation of the loading rate acquisition system 2 and the management server 30 in the loading management system 1 according to the present example embodiment will be further described with reference to FIG. 4. FIG. 4 is a flowchart illustrating the operations of the loading rate acquisition system 2 and the management server 30 in the loading management system 1 according to the present example embodiment. With these operations, the information processing method according to the present example embodiment is performed.

For example, in a vehicle berth such as a distribution center, the loads G are loaded into the cargo space 42 by a driver of the vehicle 40, a loading worker, or the like at the vehicle 40 having the ranging apparatus 100 provided on the ceiling of the cargo space 42. The loading of the loads G into the cargo space 42 may be performed by manual work or may be performed by using equipment such as a forklift, a lifter, a crane, a winch, or the like, for example.

The control unit 220 of the loading rate acquisition system 2 determines whether or not an acquisition instruction that provides an instruction to acquire a loading rate in the cargo space 42 of the vehicle 40 is input (step S102) and stands by until the acquisition instruction is input (step S102, NO). The control unit 220 can wait for switch input made by a driver, a loading worker, or the like or input of a door closure signal indicating that the door of the cargo space 42 has been closed, for example, as the acquisition instruction to acquire a loading rate.

If the control unit 220 determines that an acquisition instruction to acquire a loading rate is input (step S102, YES), the control unit 220 controls the ranging apparatus 100 and causes the ranging apparatus 100 to acquire distance distribution information (step S104). The ranging apparatus 100 acquires distance distribution information indicating a distribution of distances from the ranging apparatus 100 to the loads G or the floor surface 42a across the reference surface, as described above in accordance with the control of the control unit 220.

Next, the vacant space calculation unit 232 calculates the volume or the floor surface area of the vacant space where the load G can be loaded in the cargo space 42 based on the distance distribution information acquired by the ranging apparatus 100 (step S106).

Next, the loading rate calculation unit 234 calculates the loading rate of the loads G in the cargo space 42 based on the volume or the floor surface area of the vacant space calculated by the vacant space calculation unit 232 (step S108).

Next, the control unit 220 transmits the loading rate of the loads G calculated by the loading rate calculation unit 234 to the management server 30 via the network NW (step S110).

In response to receiving the loading rate from the control apparatus 200 of the loading rate acquisition system 2, the control unit 32 of the management server 30 registers the received loading rate in the management DB 34a (step S112). The control unit 32 can register and manage loading rates in association with the identification information on the vehicles 40 in the management DB 34a on a vehicle 40 basis. The control unit 32 can provide the loading rate managed by the management DB 34a in such a way for various purposes such as for a dispatching plan of the vehicles 40, for example.

Further, the control unit 32 compares the loading rate of the loads G calculated by the loading rate calculation unit 234 with a threshold set in advance (step S114). The threshold is a reference used for determining the level of a loading rate and is set and stored in the storage unit 34 or the like in advance. The threshold can be suitably set by a manager of a freight company or the like that manage the vehicles 40, for example, and can be set in accordance with various factors such as the type of the load G, the type of the vehicle 40, the owner of the load G, a transportation period, or the like, for example.

If the control unit 32 determines that the loading rate is less than or equal to the threshold (step S114, YES), the control unit 32 recognizes that the loading rate of the loads G in the cargo space 42 is low and performs a notification process to issue a notification indicating that the loading rate is low (step S116). The control unit 32 can transmit the notification indicating that the loading rate is low to a mobile information terminal (not illustrated) carried by a driver of the vehicle 40 of interest via the network NW and thereby notify the driver, for example, as the notification process. Further, the control unit 32 can transmit the notification indicating that the loading rate is low to an information terminal used by a manager who manages the vehicle 40 of interest via the network NW and thereby notify the manager, for example, as the notification process. Accordingly, for example, the driver or the manager is able to cancel transportation of the loads G by the vehicle 40 with a low loading rate of the loads G in the cargo space 42. In such a case, the driver or the manager may take a countermeasure to increase the loading rate of the loads G in the cargo space 42, such as adding and loading another load G into the cargo space 42, changing the type of the load G to be loaded into the cargo space 42, or the like, for example.

Note that the management server 30 can be configured to not permit transportation of loads if the loading rate is less than or equal to the threshold and to permit transportation of loads by the vehicle 40 if the loading rate exceeds the threshold. In such a case, if the control unit 32 determines that the loading rate exceeds the threshold (step S114, NO), the control unit 32 can perform a permission process to permit transportation of the loads G.

The control unit 32 can transmit a notification indicating that transportation is permitted to a mobile information terminal (not illustrated) carried by the driver of the vehicle 40 of interest and notify the driver via the network NW, for example, as the permission process. Further, the control unit 32 can transmit a notification indicating that transportation is permitted to an information terminal used by a manager who manages the vehicle 40 of interest and notify the manager via the network NW, for example, as the permission process. This enables the driver to perform transportation of the loads G using the vehicle 40, for example. Further, the manager can let the driver perform transportation of the loads G using the vehicle 40. In addition to the above, the control unit 32 can control whether or not to permit the vehicle 40 to leave a garage by controlling an opening operation of an exit gate through which the vehicle 40 is to pass and thereby can determine whether or not to permit the transportation of the loads G, for example.

As described above, according to the present example embodiment, since a loading rate of the loads G in the cargo space 42 of the vehicle 40 is acquired based on distance distribution information acquired by the ranging apparatus 100, the loading rate of the loads G in the cargo space 42 can be accurately acquired. Therefore, according to the present example embodiment, efficient transportation of the loads G can be realized with the use of the accurately acquired loading rate of the loads G.

### Second Example Embodiment

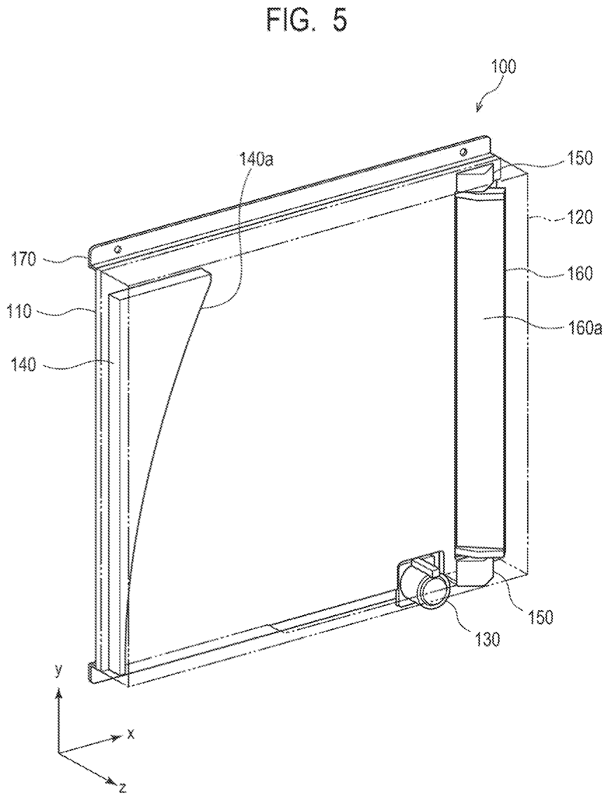

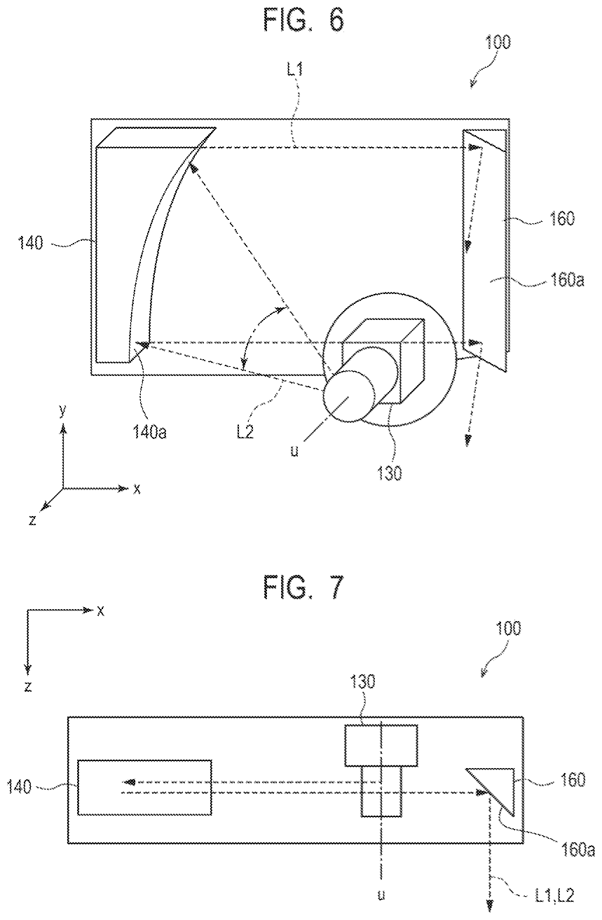

A ranging apparatus according to a second example embodiment of the present invention will be described with reference to FIG. 5 to FIG. 7. FIG. 5 is a schematic perspective view illustrating the structure of the ranging apparatus 100 according to the second example embodiment. FIG. 6 is a schematic diagram illustrating the structure of the ranging apparatus 100 when viewed from the front. FIG. 7 is a schematic diagram illustrating the structure of the ranging apparatus 100 when viewed from the top. The structure of the ranging apparatus 100 will be described with cross-reference to these drawings. Note that an x-axis, a y-axis, and a z-axis illustrated in each drawing are provided for assistance of description and are not intended to limit the installation direction of the ranging apparatus 100. In the present example embodiment, first, a configuration that enables a parallel scan in which a light path moves in the y-axis direction in parallel will be described as a basic configuration of the ranging apparatus 100 according to the first example embodiment. Note that, for example, together with a configuration that enables a parallel scan in which a light path moves in the x-axis direction in parallel, such a combination can be employed as the ranging apparatus 100 according to the first example embodiment, as described later.

As illustrated in FIG. 5, the ranging apparatus 100 has a base 110, a cover 120, a sensor unit 130, a parabolic reflecting mirror 140, a position adjustment mechanism 150, a plane reflecting mirror 160, and an attachment part 170.

The base 110 is a rectangular plate-like member and functions as a part of a casing of the ranging apparatus 100. Further, the base 110 has a function of fixing the sensor unit 130, the parabolic reflecting mirror 140, the plane reflecting mirror 160, and the like to predetermined positions.

The cover 120 is a lid covering the base 110 and functions as a part of a casing of the ranging apparatus 100. The parabolic reflecting mirror 140, the position adjustment mechanism 150, and the plane reflecting mirror 160 are arranged in the internal space of the casing surrounded by the base 110 and the cover 120.

The sensor unit 130 is a two-dimensional LiDAR device. As illustrated in FIG. 6, the sensor unit 130 can perform rotation scan about the rotation axis u. The rotation axis u may also be referred to as a first rotation axis. The sensor unit 130 has a laser device that emits laser light and a photoelectric conversion element that receives reflected light reflected by a target object and converts the reflected light into an electrical signal. The sensor unit 130 is arranged in a notch formed in the lower part of the base 110 and the cover 120, as illustrated in FIG. 5. The light emitted from the sensor unit 130 is caused to enter a reflective surface 140a of the parabolic reflecting mirror 140.

As an example of a distance detection scheme performed by the sensor unit 130, a Time Of Flight (TOF) scheme may be used. The TOF scheme is a method for measuring a distance by measuring time from emission of light to reception of reflected light.

Note that the laser light emitted from the sensor unit 130 may be visible light or may be invisible light such as an infrared ray. Such laser light may be an infrared ray having a wavelength of 905 nm, for example.

The parabolic reflecting mirror 140 is a reflecting mirror having a reflective surface 140a. The parabolic reflecting mirror 140 may also be referred to as a first reflecting mirror. The reflective surface 140a forms a parabola whose focal point is a point on the rotation axis u on a cross section perpendicular to the rotation axis u (the xy plane in FIG. 6). In other words, the sensor unit 130 is arranged near the focal point of the parabola formed by the reflective surface 140a, and the rotation axis u is arranged at a position passing through the focal point of the parabola formed by the reflective surface 140a. The rotation axis u is parallel to the z-axis in FIG. 6. The equation of the parabola is expressed by Equation (1) below, where the coordinates of the parabola vertex are denoted as P(0, 0), and the coordinates of the focal point are denoted as (a, 0).

[Math. 1]

y²=4ax (1)

According to the mathematical nature of a parabola, when light emitted from the sensor unit 130 is reflected by a reflective surface 140a, the emission direction of reflected light is parallel to the parabola axis regardless of the angle of the emission light. That is, as illustrated in FIG. 6, for a light path L1 and a light path L2 having different emission angles from the sensor unit 130, rays of reflected light reflected by the reflective surface 140a are parallel to each other. In such a way, with the sensor unit 130 being arranged at the focal point of the reflective surface 140a, this enables a parallel scan in which a light path moves in the y-axis direction in parallel in response to rotation of emission light.

Note that the material of the parabolic reflecting mirror 140 may be an aluminum alloy whose primary component is aluminum, for example. In such a case, the reflective surface 140a may be formed by smoothing the surface of an aluminum alloy by mirror polishing or plating, for example. Note that other parabolic reflecting mirrors described later may be formed of the same material and by the same process.

The plane reflecting mirror 160 is a reflecting mirror having a reflective surface 160a at least partially forming a plane. The plane reflecting mirror 160 may also be referred to as a second reflecting mirror. The reflective surface 160a is provided on light paths of reflected light from the reflective surface 140a. As illustrated in FIG. 6 and FIG. 7, the plane reflecting mirror 160 changes the direction of light reflected by the reflective surface 140a to a different direction from the xy plane. More specifically, reflected light from the plane reflecting mirror 160 travels in substantially the z-axis direction, that is, in a direction substantially parallel to the rotation axis u. The reflected light from the plane reflecting mirror 160 is emitted out of the ranging apparatus. Accordingly, the direction of the emission light from the ranging apparatus 100 is not limited to a direction parallel to the axis of the reflective surface 140a.

Note that the material of the plane reflecting mirror 160 may be an aluminum alloy whose primary component is aluminum, for example, in the same manner as the parabolic reflecting mirror 140. In such a case, the reflective surface 160a of the plane reflecting mirror 160 may be formed by smoothing in the same manner as for the reflective surface 140a or may be formed by attaching an aluminum alloy plate having specular gloss to a base member. Note that other plane reflecting mirrors described later may be formed of the same material and by the same process.

Herein, the cover 120 is configured to neither absorb nor reflect a reflected light from the plane reflecting mirror 160. Specifically, for example, a region of the cover 120 through which reflected light from the plane reflecting mirror 160 passes may be formed of a transparent material. An example of a transparent material may be an acrylic resin. Alternatively, a window may be provided so that a region of the cover 120 through which reflected light from the plane reflecting mirror 160 passes is a hollow.

The attachment part 170 is a portion by which the ranging apparatus 100 is attached and fixed to the ceiling or the like of the cargo space 42. By being fixed by the attachment part 170, the ranging apparatus 100 can be attached in any orientations. The position adjustment mechanism 150 is a mechanism used for finely adjusting the position of the plane reflecting mirror 160 when attaching the ranging apparatus 100 to the ceiling or the like of the cargo space 42. Note that a drive mechanism that moves the plane reflecting mirror 160 may be provided instead of the position adjustment mechanism 150.

The light paths L1 and L2 illustrated in FIG. 6 and FIG. 7 are illustration for light paths when light is emitted out of the sensor unit 130. In contrast, light is reflected by a target object and enters the ranging apparatus 100 passes through substantially the same path as the light paths L1 and L2 in the opposite direction and is received by the sensor unit 130.

The ranging apparatus 100 of the present example embodiment is structured thick in the axial direction of the parabolic reflecting mirror 140 due to the thickness of the parabolic reflecting mirror 140, constraints of the arrangement position of the sensor unit 130, or the like. In contrast, the ranging apparatus 100 of the present example embodiment has the plane reflecting mirror 160 that reflects light reflected from the parabolic reflecting mirror 140. The plane reflecting mirror 160 can change the direction of the emission light from the ranging apparatus 100 to a different direction from the axial direction of the parabola formed by the parabolic reflecting mirror 140. Thus, since the ranging apparatus 100 of the present example embodiment can direct the light emission direction to a different direction from the axial direction of the parabolic reflecting mirror 140, the thickness in the light emission direction can be reduced. Accordingly, the ranging apparatus 100 of the present example embodiment can be installed on the ceiling or the like of the cargo space 42 in a space-saving manner. Therefore, according to the present example embodiment, the ranging apparatus 100 having improved flexibility for an installation place is provided.

Further, in the ranging apparatus 100 according to the present example embodiment, the reflective surface 140a of the parabolic reflecting mirror 140 is provided so as to be absent at the parabola vertex.

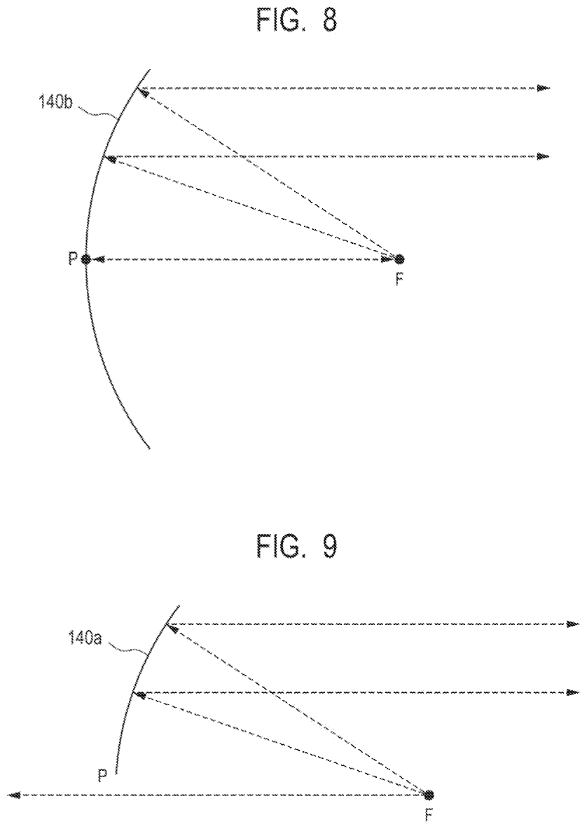

The reason for such a configuration will be described with reference to FIG. 8 to FIG. 10.

FIG. 8 is a diagram of light paths when a reflective surface 140b is provided through the parabola vertex P. For simplified illustration, the sensor unit 130 is indicated in a simplified manner as a point light source arranged at the focal point F of the reflective surface 140b. When light emitted from the focal point F is not parallel to the parabola axis (when the light does not travel in a direction toward the vertex P), the reflected light does not pass through the focal point F. However, when light emitted from the focal point F is parallel to the parabola axis (the light travels in a direction toward the vertex P) and is reflected at the vertex P, the reflected light passes through the focal point F. Therefore, light emitted from the sensor unit 130 re-enters the sensor unit 130. In such a case, noise may occur on a signal measured when the sensor unit 130 receives reflected light different from reflected light from a target object. In such a way, if the reflective surface 140b is provided thorough the parabola vertex P, detection accuracy may decrease, and sufficient detection accuracy may be unable to be ensured.

In contrast, in the ranging apparatus 100 of the present example embodiment, as illustrated in FIG. 9, the reflective surface 140a is provided so as to be absent at the parabola vertex P. Thus, even when light emitted from the focal point F is parallel to the parabola axis, the light is not reflected. Therefore, since reflected light does not re-enter the sensor unit 130, it is possible to suppress a reduction in detection accuracy. As described above, according to the present example embodiment, because the reflective surface 140a of the parabolic reflecting mirror 140 is provided so as to be absent at the parabola vertex, the ranging apparatus 100 having improved detection accuracy is provided.

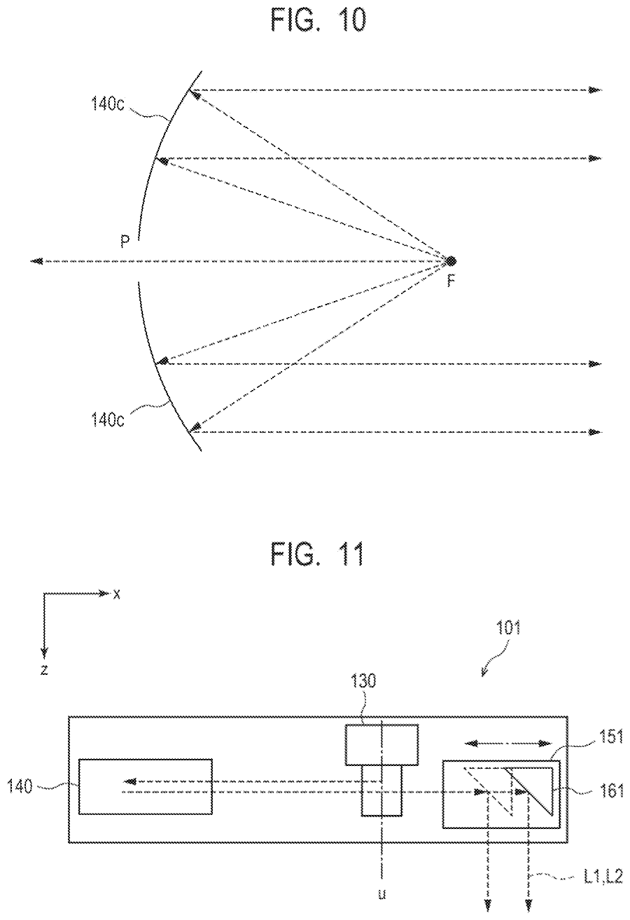

Note that, although the reflective surface 140a is arranged on one side of the parabola axis in FIG. 9, a configuration in which reflective surfaces 140c are arranged on both sides so as not to include the parabola vertex P may be employed as indicated in a modified example illustrated in FIG. 10. A specific configuration example corresponding to this modified example will be described later.

### Third Example Embodiment

Next, as a third example embodiment of the present invention, a configuration example of a ranging apparatus that can move a plane reflecting mirror in parallel will be described. Description of components common to those in the example embodiments described above will be omitted or simplified. In the third to eighth example embodiments below, ranging apparatuses 101, 102, 300, 301, 400, and 500 will be described as a specific example of a ranging apparatus that can be employed as the configuration of the ranging apparatus 100 of the first example embodiment.

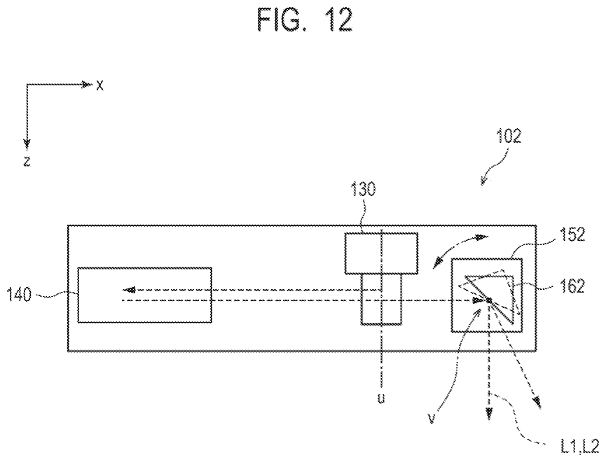

FIG. 11 is a schematic diagram illustrating the structure of the ranging apparatus 101 of the present example embodiment when viewed from the top. The ranging apparatus 101 of the present example embodiment has a drive mechanism 151 instead of the position adjustment mechanism 150 and has a plane reflecting mirror 161 instead of the plane reflecting mirror 160. The drive mechanism 151 drives the plane reflecting mirror 161 in parallel to the axial direction of the parabolic reflecting mirror 140 (the x-axis direction in FIG. 11). The drive mechanism 151 includes a drive device such as a motor. Further, the drive mechanism 151 includes a device that acquires position information on the plane reflecting mirror 161, such as an encoder. These devices are controlled by the control apparatus 200. Further, the position information on the plane reflecting mirror 161 acquired by the drive mechanism 151 is supplied to the control apparatus 200.

When the plane reflecting mirror 161 is driven by the drive mechanism 151 and moves in the x-axis direction in parallel, reflected light from the plane reflecting mirror 161 similarly moves in the x-axis direction in parallel. This enables the ranging apparatus 101 of the present example embodiment to perform a scan to move reflected light from the plane reflecting mirror 161 in the x-axis direction in parallel. Further, the ranging apparatus 101 of the present example embodiment can also perform a scan to move reflected light from the plane reflecting mirror 161 in the y-axis direction in parallel in the same manner as in the second example embodiment. Therefore, the ranging apparatus 101 of the present example embodiment functions as a three-dimensional sensor device that can acquire three-dimensional position information by combining two-dimensional scan in the x-axis direction and the y-axis direction and distance measurement in the z-axis direction in addition that the same advantageous effects as in the second example embodiment can be obtained.

### Fourth Example Embodiment

Next, as a fourth example embodiment of the present invention, a configuration example of a ranging apparatus that can rotate and move a plane reflecting mirror will be described. Description of components common to those in the second example embodiment will be omitted or simplified.

FIG. 12 is a schematic diagram illustrating the structure of the ranging apparatus 102 of the present example embodiment when viewed from the top. The ranging apparatus 102 of the present example embodiment has a drive mechanism 152 instead of the position adjustment mechanism 150 and has a plane reflecting mirror 162 instead of the plane reflecting mirror 160. The drive mechanism 152 drives the plane reflecting mirror 162 so as to rotate the plane reflecting mirror 162 about the rotation axis v parallel to the y-axis. The position of the rotation axis v can be any position as long as the direction of reflected light from the plane reflecting mirror 162 changes in accordance with the rotation and may be, for example, on a path through which reflected light from the parabolic reflecting mirror 140 passes. The drive mechanism 152 includes a drive device such as a motor. Further, the drive mechanism 152 includes a device that acquires angle information on the plane reflecting mirror 162 such as an encoder. These devices are controlled by the control apparatus 200. Further, angle information on the plane reflecting mirror 162 acquired by the drive mechanism 152 is supplied to the control apparatus 200.

When the plane reflecting mirror 162 is driven by the drive mechanism 152 and rotated and moved, the direction of reflected light from the plane reflecting mirror 162 is also rotated. This enables the ranging apparatus 102 of the present example embodiment to perform a scan to rotate and move the direction of reflected light from the plane reflecting mirror 162. Further, the ranging apparatus 102 of the present example embodiment can also perform a scan to move reflected light from the plane reflecting mirror 162 in the y-axis direction in parallel in the same manner as in the second example embodiment. Therefore, the ranging apparatus 102 of the present example embodiment functions as a three-dimensional sensor device that can acquire three-dimensional position information by combining rotation movement on the rotation axis v, parallel movement in the y-axis direction, and distance measurement, in addition that the same advantageous effects as in the second example embodiment can be obtained.

### Fifth Example Embodiment

Next, as a fifth example embodiment of the present invention, a configuration example of a ranging apparatus further having a logarithm spiral reflecting mirror will be described. Description of components common to those in the example embodiments described above will be omitted or simplified.

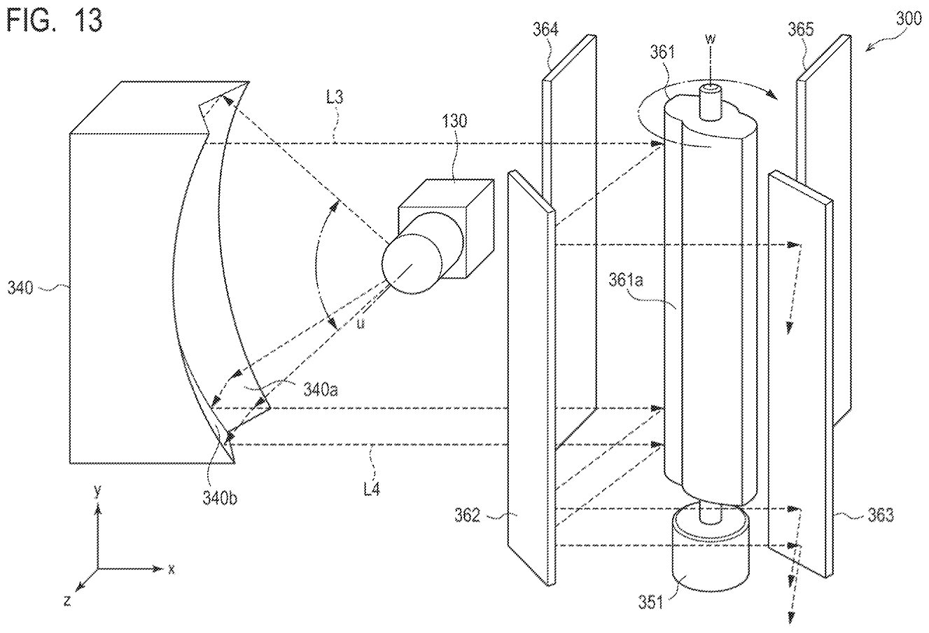

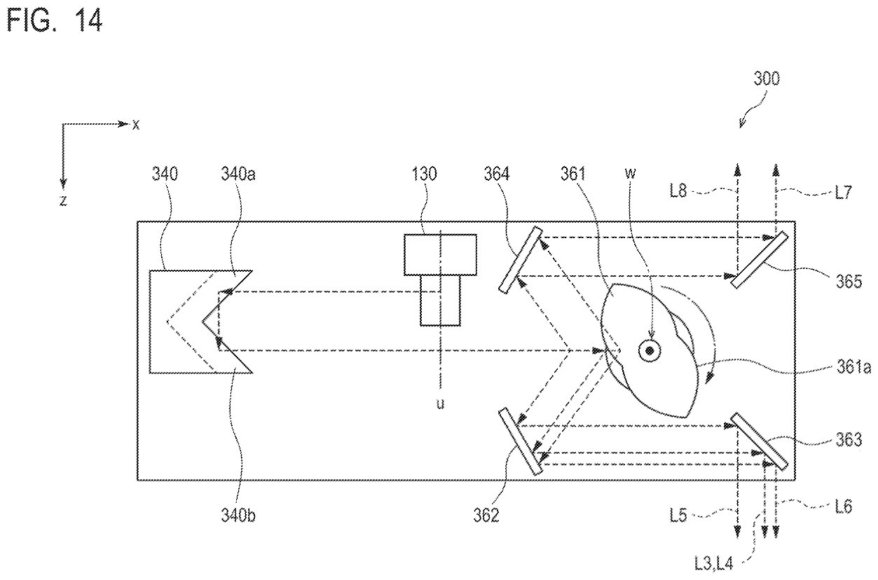

FIG. 13 is a schematic perspective view illustrating the structure of the ranging apparatus 300 according to the fifth example embodiment. FIG. 14 is a schematic diagram illustrating the structure of the ranging apparatus 300 when viewed from the top. The structure of the ranging apparatus 300 will be described with cross-reference to FIG. 13 and FIG. 14. Note that FIG. 13 and FIG. 14 may omit some depiction of components not required for description of light paths, such as the base 110, the cover 120, the attachment part 170, or the like.

The ranging apparatus 300 has the sensor unit 130, a parabolic reflecting mirror 340, a drive mechanism 351, a logarithm spiral reflecting mirror 361, and plane reflecting mirrors 362, 363, 364, and 365. The parabolic reflecting mirror 340 has reflective surfaces 340a and 340b. Each of the reflective surfaces 340a and 340b forms a parabola whose focal point is a point on the rotation axis u on a cross section perpendicular to the rotation axis u (the xy plane in FIG. 13). The reflective surface 340a and the reflective surface 340b are in a positional relationship of being perpendicular to each other on the xz plane, as illustrated in FIG. 14. Note that the parabolic reflecting mirror 340, the plane reflecting mirror 363, the logarithm spiral reflecting mirror 361, and the plane reflecting mirror 365 may also be referred to as a first reflecting mirror, a second reflecting mirror, a third reflecting mirror, and a fourth reflecting mirror, respectively.

The light emitted from the sensor unit 130 in the negative x-axis direction is reflected at the reflective surface 340a in the z-axis direction and then reflected at the reflective surface 340b in the positive x-axis direction toward the logarithm spiral reflecting mirror 361. By shifting the light path in the z direction with two times of reflection at the reflective surfaces 340a and 340b, it is possible that reflected light at the parabolic reflecting mirror 340 is not blocked by the sensor unit 130. Further, since reflected light does not re-enter the sensor unit 130, detection accuracy can be improved for the same reason as described with reference to FIG. 8 to FIG. 10.

The logarithm spiral reflecting mirror 361 has a columnar shape and has a reflective surface 361a forming a logarithm spiral on the side surface thereof. Light emitted from the sensor unit 130 is reflected by the reflective surface 361a. The logarithm spiral reflecting mirror 361 can be rotated about the rotation axis w by the drive mechanism 351. At this time, light reflected at the reflective surface 361a moves in parallel in accordance with the angle of the logarithm spiral reflecting mirror 361. Note that the rotation axis w may also referred to as a second rotation axis.

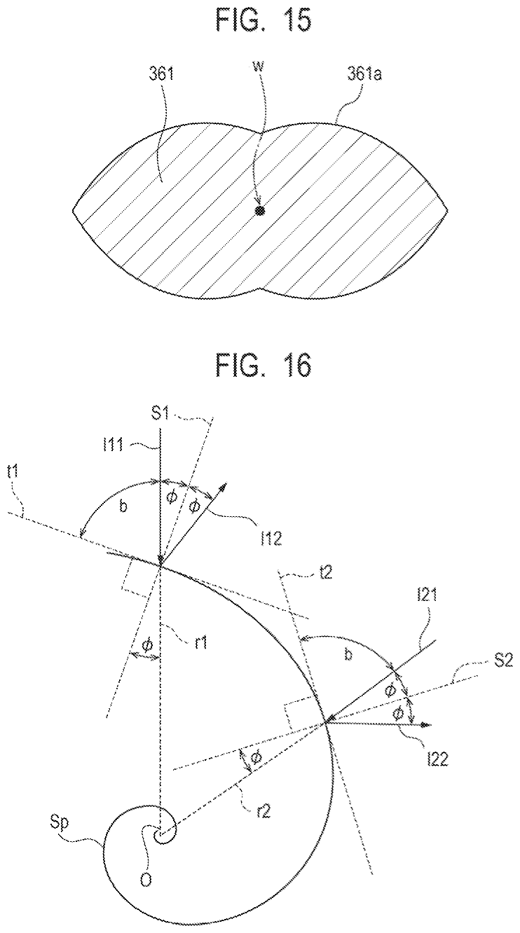

The structure of the logarithm spiral reflecting mirror 361 will be described in more detail with reference to FIG. 15 and FIG. 16. FIG. 15 is a sectional view of the logarithm spiral reflecting mirror 361 according to the present example embodiment taken along a plane perpendicular to the rotation axis w. The reflective surface 361a that is the side surface of the logarithm spiral reflecting mirror 361 forms a closed curve in which four logarithm spirals are continuously connected on a cross section perpendicular to the rotation axis w. With such a closed curve having the continuously connected logarithm spirals, this realizes a configuration in which the whole reflective surface 361a, which light emitted from the sensor unit 130 may enter, forms a logarithm spiral on the cross section perpendicular to the rotation axis w. Accordingly, reflected light can be utilized for a scan even when light enters any surface of the logarithm spiral reflecting mirror 361. Note that a logarithm spiral may also be referred to as an equiangular spiral or a Bernoulli's spiral.

FIG. 16 is a diagram illustrating reflection of light at a reflective surface forming a logarithm spiral. A logarithm spiral Sp is expressed by a polar equation of Equation (2) below, where a dynamic radius of the polar coordinate is denoted as r, a deflection angle in the polar coordinate is denoted as θ, the value of r when θ is zero is “a”, and an angle of a tangential line of the logarithm spiral relative to a line passing through the center of the logarithm spiral is b.

[Math. 2]

r=a·exp(θ·cot b) (2)

The relationship between incident light I11 and 121 traveling to the origin 0 of the polar equation of Equation (2) from outside of the logarithm spiral Sp and corresponding reflected light 112 and 122 is now considered. The tangential lines at points where the incident light I11 and the incident light 121 are reflected on the logarithm spiral Sp are denoted as t1 and t2, and the normal lines thereof are denoted as S1 and S2, respectively. The incident light I11 is reflected at the point on a dynamic radius r1 of the logarithm spiral Sp, and the incident light 121 is reflected at the point on a dynamic radius r2 of the logarithm spiral Sp (note that r1 ≠r2). In this case, due to the nature of the logarithm spiral Sp, both of the angle between the incident light I11 and the tangential line t1 and the angle between the incident light 121 and the tangential line t2 are b. Therefore, the incident angle σ between the incident light I11 and the normal line S1 and the incident angle σ between the incident light 121 and the normal line S2 are the same. Further, the reflection angle σ between the reflected light 112 and the normal line S1 and the reflection angle σ between the reflected light 122 and the normal line S2 are the same. When σ and b are angles expressed by the circular measure, the relationship between σ and b is expressed as Equation (3) below.

$$\begin{matrix}[ Math . 3 ] & \\ ϕ = \frac{π}{2} - b & ( 3 )\end{matrix}$$

It is found from the above that the incident light I11 traveling from outside of the logarithm spiral Sp to the origin O is reflected at the same reflection angle σ when reflected at any point on the logarithm spiral Sp. Thus, when the logarithm spiral Sp is rotated about the origin O, although the point at which the incident light I11 to the logarithm spiral Sp is reflected changes, the direction in which the reflected light I12 is reflected does not change, and thus the reflected light I12 moves in parallel.

To utilize such a nature, the logarithm spiral reflecting mirror 361 of the present example embodiment is formed such that at least a part of the reflective surface is a logarithm spiral whose rotation axis w corresponds to the origin O on the cross section perpendicular to the rotation axis w. Accordingly, by rotating the logarithm spiral reflecting mirror 361 around the rotation axis w, it is possible to perform a scan such that light reflected by the reflective surface 361a moves in parallel.

Turning back to FIG. 14, a parallel scan with reflected light by using the logarithm spiral reflecting mirror 361 will be described. Light reflected by the logarithm spiral reflecting mirror 361 enters and is reflected by either the plane reflecting mirror 362 or the plane reflecting mirror 364 in accordance with the angle of the logarithm spiral reflecting mirror 361. The light reflected by the plane reflecting mirror 362 is reflected by the plane reflecting mirror 363 and emitted out of the ranging apparatus 300. At this time, the emission direction is the positive z-axis direction. The light reflected by the plane reflecting mirror 364 is reflected by the plane reflecting mirror 365 and emitted out of the ranging apparatus 300. At this time, the emission direction is the negative z-axis direction.

When the logarithm spiral reflecting mirror 361 is rotated clockwise as illustrated in FIG. 14, the light emitted out of the ranging apparatus 300 moves in parallel from the light path L5 to the light path L6. When the logarithm spiral reflecting mirror 361 is further rotated with the emission light being on the light path L6, the emission light changes discontinuously from the light path L6 to the light path L7. The emission light then moves in parallel from the light path L7 to the light path L8 and discontinuously changes from the light path L8 to the light path L5. In such a way, the ranging apparatus 300 of the present example embodiment can alternatingly scan different directions of the positive direction and the negative direction of the z-axis. Note that a scan with light directed to either one of the different directions of the positive direction and the negative direction of the z-axis can be used for the ranging apparatus 100 in the loading rate acquisition system 2.

Accordingly, the ranging apparatus 300 of the present example embodiment can perform a scan to move emission light in the x-axis direction in parallel. Further, the ranging apparatus 300 of the present example embodiment can also perform a scan to move the emission light in the y-axis direction in parallel in the same manner as in the second example embodiment. Therefore, the ranging apparatus 300 of the present example embodiment functions as a three-dimensional sensor device that can acquire three-dimensional position information by combining two-dimensional scan in the x-axis direction and the y-axis direction and distance measurement in the z-axis direction in addition that the same advantageous effects as in the second example embodiment can be obtained. Furthermore, since the ranging apparatus 300 of the present example embodiment can alternatingly scan the positive direction and the negative direction of the z-axis, it is possible to perform ranging of two directions different from each other by using a single ranging apparatus 300.

### Sixth Example Embodiment

Next, as a sixth example embodiment of the present invention, a configuration example of a ranging apparatus having two optical systems will be described. Description of components common to those in the example embodiments described above will be omitted or simplified.

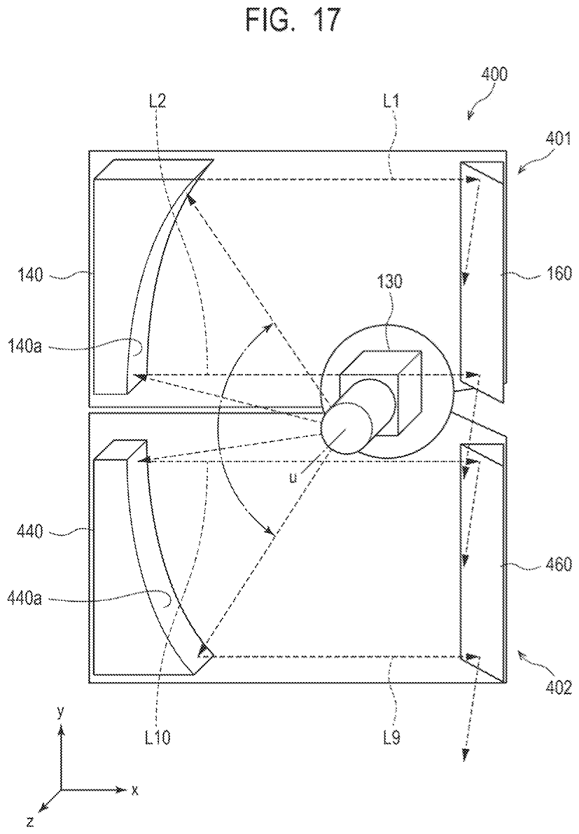

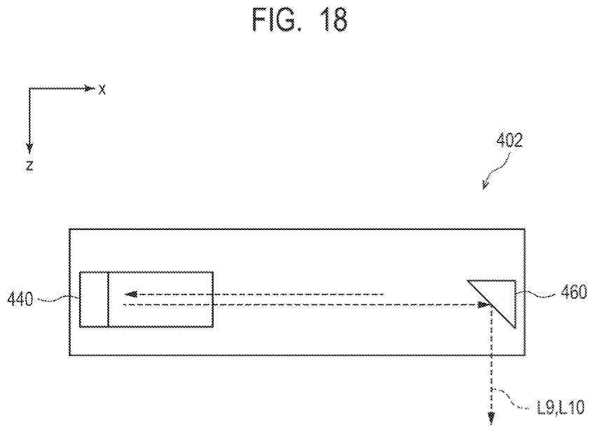

FIG. 17 is a schematic diagram illustrating the structure of the ranging apparatus 400 according to the sixth example embodiment when viewed from the front. FIG. 18 is a schematic diagram illustrating the structure of the ranging apparatus 400 when viewed from the top. The structure of the ranging apparatus 400 will be described with cross-reference to these drawings.

The ranging apparatus 400 has a first optical system 401 and a second optical system 402. The first optical system 401 has the sensor unit 130, the parabolic reflecting mirror 140, and the plane reflecting mirror 160. Since the first optical system 401 is the same as that of the ranging apparatus 100 of the second example embodiment, the description thereof will be omitted. Note that the top view of the first optical system 401 is the same as FIG. 7.

The second optical system 402 has a parabolic reflecting mirror 440 and a plane reflecting mirror 460. The parabolic reflecting mirror 440 has a reflective surface 440a. The reflective surface 440a forms a parabola whose focal point is a point on the rotation axis u on the cross section perpendicular to the rotation axis u (the xy plane in FIG. 17). The parabolic reflecting mirror 440 has line-symmetrical structure with respect to the parabolic reflecting mirror 140. Further, the plane reflecting mirror 460 has line-symmetrical structure with respect to the plane reflecting mirror 160. The parabolic reflecting mirror 140 and the parabolic reflecting mirror 440 are arranged at positions symmetrical to the parabola axis. Further, the plane reflecting mirror 160 and the plane reflecting mirror 460 are arranged at positions symmetrical to the parabola axis. Note that the structure of a casing accommodating these components of the second optical system 402 may be structure resulted when the casing illustrated in FIG. 5 of the second example embodiment is inverted in the y direction, for example.

When emitted from the sensor unit 130 in the left-under direction in FIG. 17, light enters the reflective surface 440a. The light reflected by the reflective surface 440a is parallel to the parabola axis, as illustrated by the light paths L9 and L10. The light reflected by the reflective surface 440a is emitted out of the second optical system 402, as illustrated in FIG. 18.

Herein, both of the reflective surface 140a of the parabolic reflecting mirror 140 and the reflective surface 440a of the parabolic reflecting mirror 440 are provided so as to be absent at the parabola vertex. This configuration corresponds to the diagram of light paths illustrated in FIG. 10. Accordingly, as described in the illustration of FIG. 8 to FIG. 10, since reflected light at the parabola vertex does not re-enter the sensor unit 130, it is possible to suppress a reduction in detection accuracy. Therefore, also in the present example embodiment, the ranging apparatus 400 having improved detection accuracy can be provided in the same manner as in the second example embodiment. Furthermore, in the present example embodiment, it is possible to broaden a scan range of emission light by using two optical systems.

### Seventh Example Embodiment

Next, as a seventh example embodiment of the present invention, a configuration example of a ranging apparatus having a logarithm spiral reflecting mirror and two parabolic reflecting mirrors will be described. Description of components common to those in the example embodiments described above will be omitted or simplified.

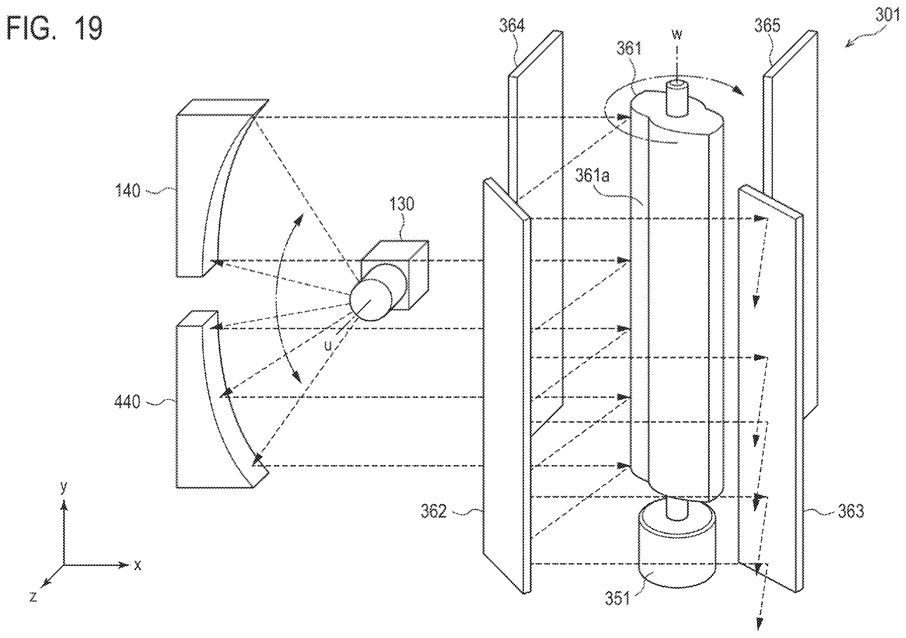

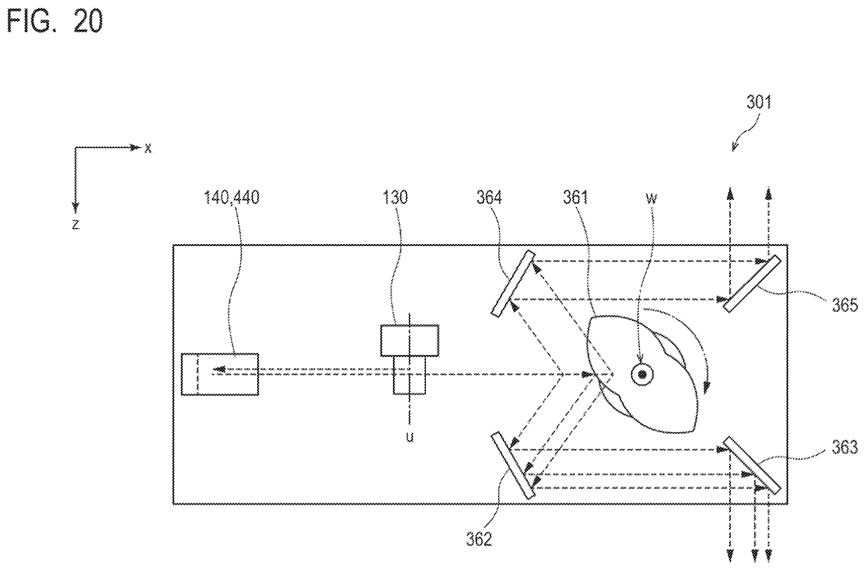

FIG. 19 is a schematic perspective view illustrating the structure of the ranging apparatus 301 according to the seventh example embodiment. FIG. 20 is a schematic diagram illustrating the structure of the ranging apparatus 301 when viewed from the top. The ranging apparatus 301 of the present example embodiment is a ranging apparatus in which, in the ranging apparatus 300 in the fifth example embodiment, the parabolic reflecting mirror 340 is replaced with the parabolic reflecting mirror 140 and the parabolic reflecting mirror 440 of the sixth example embodiment. The same advantageous effects as those in the fifth example embodiment are obtained also in the present example embodiment. Further, in the present example embodiment, the structure of the parabolic reflecting mirrors is simplified compared to the case of the fifth example embodiment.

### Eighth Example Embodiment

Next, as an eighth example embodiment of the present invention, a configuration example of a ranging apparatus having a plurality of LiDAR devices each formed of a Micro Electro Mechanical System (MEMS) will be described. Description of components common to those in the example embodiments described above will be omitted or simplified.

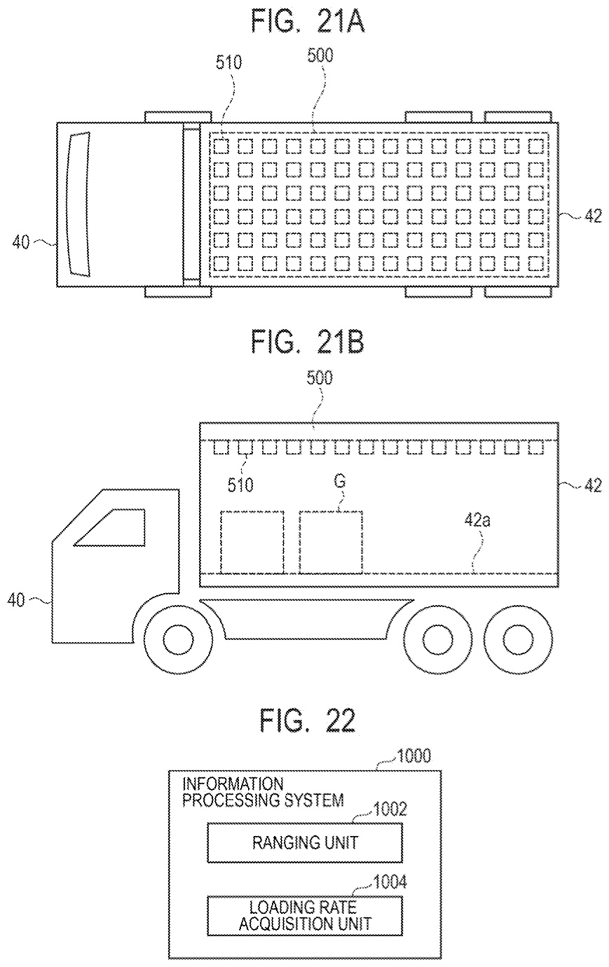

FIG. 21A is a schematic diagram illustrating the structure of a ranging apparatus 500 according to the eighth example embodiment when viewed from the top. FIG. 21B is a schematic diagram illustrating the structure of the ranging apparatus 500 according to the eighth example embodiment when viewed from the side. The ranging apparatus 500 according to the present example embodiment is installed on the ceiling of the cargo space 42. The ranging apparatus 500 has a plurality of LiDAR devices 510 each formed of a MEMS including MEMS structure such as a MEMS mirror. The LiDAR device 510 is configured to be able to perform a scan with emitted light by using a MEMS mirror, for example.

The plurality of LiDAR devices 510 are arranged in a matrix along a plane parallel to the floor surface 42a of the cargo space 42, for example, as illustrated in FIG. 21A and FIG. 21B, for example. Each of the plurality of LiDAR devices 510 acquires distance information on the distance from the ranging apparatus 500 to the load G loaded on the floor surface 42a of the cargo space 42 or the floor surface 42a of the cargo space 42 in a predetermined range. Accordingly, the ranging apparatus 500 of the present example embodiment can acquire distance distribution information indicating a two-dimensional distribution of distances from the ranging apparatus 100 to the floor surface 42a or the load G in the cargo space 42 across the reference surface.

### Another Example Embodiment

The loading rate acquisition system that is an information processing system described in the above example embodiments may be configured as illustrated in FIG. 22 according to yet another example embodiment.

FIG. 22 is a block diagram illustrating a configuration of the information processing system according to another example embodiment.

As illustrated in FIG. 22, an information processing system 1000 according to another example embodiment has a ranging unit 1002 that acquires a distribution of distances to a load loaded on a load-carrying platform of a vehicle or to a floor surface of the load-carrying platform and a loading rate acquisition unit 1004 that acquires a loading rate of loads on the load-carrying platform based on the distribution of distances.

According to the information processing system 1000 of another example embodiment, it is possible to accurately acquire a loading rate of loads on a load-carrying platform of a vehicle.

### Modified Example Embodiment

Note that all the above example embodiments are mere illustration of embodied examples in implementing the present invention, and the technical scope of the present invention is not to be construed in a limiting sense by these example embodiments. That is, the present invention can be implemented in various forms without departing from the technical concept or the primary feature thereof. For example, it should be understood that an example embodiment in which a part of the configuration of any of the example embodiments is added to another example embodiment or an example embodiment in which a part of the configuration of any of the example embodiments is replaced with a part of the configuration of another example embodiment is also one of the example embodiments to which the present invention is applicable.

For example, although the case where the vehicle 40 is a goods vehicle such as a truck has been described as an example in the above example embodiment, the case is not limited thereto. The vehicle 40 may be a railway vehicle such as a goods train, for example, other than a goods vehicle.

Further, the scope of each of the example embodiments also includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. The control apparatus 200 and the management server 30 can each function as such a computer. Further, each of the example embodiments includes not only the storage medium in which the computer program described above is stored but also the computer program itself.

As the storage medium, for example, a floppy (registered trademark) disk, a hard disk, an optical disk, a magneto-optical disk, a compact disk-read only memory (CD-ROM), a magnetic tape, a nonvolatile memory card, or a ROM can be used. Further, the scope of each of the example embodiments includes an example that operates on operating system (OS) to perform a process in cooperation with another software or a function of an add-in board without being limited to an example that performs a process by an individual program stored in the storage medium.

The whole or part of the example embodiments disclosed above can be described as, but not limited to, the following supplementary notes.

### (Supplementary Note 1)

An information processing system comprising:

a ranging unit that acquires a distribution of distances to a load loaded on a load-carrying platform of a vehicle or to a floor surface of the load-carrying platform; and

a loading rate acquisition unit that acquires a loading rate of the load on the load-carrying platform based on the distribution of the distances.

### (Supplementary Note 2)

The information processing system according to supplementary note 1, wherein the ranging unit acquires a two-dimensional distribution of the distances.

### (Supplementary Note 3)

The information processing system according to supplementary note 1 or 2, wherein the ranging unit emits light to the load or the floor surface and acquires the distribution of the distances based on reflected light from the load or the floor surface.

### (Supplementary Note 4)

The information processing system according to supplementary note 3, wherein the ranging unit performs a scan with the light emitted to the load or the floor surface.

### (Supplementary Note 5)

The information processing system according to supplementary note 4, wherein the ranging unit performs a scan with parallel light rays as the light.

### (Supplementary Note 6)

The information processing system according to any one of supplementary notes 1 to 5,

wherein the load-carrying platform is a box-shaped cargo space, and

wherein the ranging unit is installed on a ceiling of the cargo space.

### (Supplementary Note 7)

The information processing system according to any one of supplementary notes 1 to 6, wherein the loading rate acquisition unit calculates a volume or a floor surface area of a vacant space above the load-carrying platform based on the distribution of the distances.

### (Supplementary Note 8)

The information processing system according to supplementary note 7, wherein the loading rate acquisition unit calculates the loading rate based on the volume or the floor surface area of the vacant space.

### (Supplementary Note 9)

An information processing method comprising:

acquiring a distribution of distances to a load loaded on a load-carrying platform of a vehicle or to a floor surface of the load-carrying platform; and

acquiring a loading rate of the load on the load-carrying platform based on the distribution of the distances.

### (Supplementary Note 10)

A storage medium storing a program that causes a computer to perform:

causing a ranging unit to acquire a distribution of distances to a load loaded on a load-carrying platform of a vehicle or to a floor surface of the load-carrying platform; and

acquiring a loading rate of the load on the load-carrying platform based on the distribution of the distances.

As described above, while the present invention has been described with reference to the example embodiments, the present invention is not limited to the example embodiments described above. Various modifications that may be understood by those skilled in the art within the scope of the present invention can be made to the configuration and the detail of the present invention.

This application is based upon and claims the benefit of priority from Japanese Patent Application No. 2018-213592, filed on Nov. 14, 2018, the disclosure of which is incorporated herein in its entirety by reference.

### REFERENCE SIGNS LIST

1 loading management system
2 loading rate acquisition system
30 management server
40 vehicle
100, 101, 102, 300, 301, 400, 500 ranging apparatus
200 control apparatus

What is claimed is:

1. An information processing system comprising:
a ranging unit that acquires a distribution of distances to a load loaded on a load-carrying platform of a vehicle or to a floor surface of the load-carrying platform; and
a loading rate acquisition unit that acquires a loading rate of the load on the load-carrying platform based on the distribution of the distances.

2. The information processing system according to claim 1, wherein the ranging unit acquires a two-dimensional distribution of the distances.

3. The information processing system according to claim 1, wherein the ranging unit emits light to the load or the floor surface and acquires the distribution of the distances based on reflected light from the load or the floor surface.

4. The information processing system according to claim 3, wherein the ranging unit performs a scan with the light emitted to the load or the floor surface.

5. The information processing system according to claim 4, wherein the ranging unit performs a scan with parallel light rays as the light.

6. The information processing system according to claim 1,
wherein the load-carrying platform is a box-shaped cargo space, and
wherein the ranging unit is installed on a ceiling of the cargo space.

7. The information processing system according to claim 1, wherein the loading rate acquisition unit calculates a volume or a floor surface area of a vacant space above the load-carrying platform based on the distribution of the distances.

8. The information processing system according to claim 7, wherein the loading rate acquisition unit calculates the loading rate based on the volume or the floor surface area of the vacant space.

9. An information processing method comprising:
acquiring a distribution of distances to a load loaded on a load-carrying platform of a vehicle or to a floor surface of the load-carrying platform; and
acquiring a loading rate of the load on the load-carrying platform based on the distribution of the distances.

10. A non-transitory storage medium storing a program that causes a computer to perform:
causing a ranging unit to acquire a distribution of distances to a load loaded on a load-carrying platform of a vehicle or to a floor surface of the load-carrying platform; and
acquiring a loading rate of the load on the load-carrying platform based on the distribution of the distances.
